(19) United States
(12) Patent Application Publication
(10) Pub. No.: US 2011/0121561 A1
(43) Pub. Date: May 26, 2011

(54) PIPE CONNECTOR

(75) Inventor: Hsin-Fa WANG, Lu Kang Town (TW)

(73) Assignee: WININ ENTERPRISE Co., Ltd., Lu Kang Town (TW)

(21) Appl. No.: 12/623,389

(22) Filed: Nov. 21, 2009

(51) Int. Cl. F16L 37/00

(52) U.S. Cl. 285/148.2

(57) ABSTRACT

A pipe connector has a main body, a sleeve and elastic claws. The reducing flanged pipe of the main body is linked to several guiding lugs with a guiding surface. Several inclined pushing discs are formed on the inner wall of the sleeve and abutted with the guiding lugs. A radiative swinging baseline facing the inner wall of the sleeve is formed at the center of the main body. With the lowering force applied to the sleeve, the guiding lug can be elastically accumulated to swing inwards or outwards on the swinging baseline under the guidance of the inclined pushing disc. When the force applied by the user is released, the sleeve will be resumed to move up with the resetting of the guiding lug. The pipe connector of the present invention is characterized by simple construction and more stable guidance with improved applicability and industrial benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pipe fitting, and more particularly to an innovative one involving the connector of water pipe.

2. Description of Related Art Including Information Disclosed Under 37 CFR 1.97 and 37 CFR 1.98.

The pipe connector of the present invention is generally applied to gardening or vehicle cleaning as a connection fitting between water sprayer and water pipe, or between the water pipes.

Said pipe connector is structurally configured in a manner that it can be switched conveniently and quickly with regard to the assembled positioning and release state, so the structural configuration is of utmost importance.

Generally, the switching of the assembled positioning and release state of conventional pipe connector is implemented by a sleeve assembly that can shift axially; if a force is applied by the user to pull back the sleeve, the claw preset internally will be opened to release the male joint set on the end of the water pipe. Conversely, if no any force is applied to the sleeve, the sleeve can be reset automatically through an elastic resetting mechanism, thus realizing quick assembly and release effect.

Of which, there are a variety of elastic resetting mechanisms despite that they just serve as a kind of space-saving functional component for the pipe connector. Hence, it is a technical challenge to produce an elastic resetting mechanism of simplest structure while realizing stable and applicable operation and locking effect.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

The “pipe connector” of the present invention has two technical characteristics: (1) the reducing flanged pipe of the main body is connected with the guiding lug; and (2) an inclined pushing disc is formed on the inner wall of the sleeve. With this unique design, as the guiding lug is linked to the stable main body, it is possible to realize extremely stable pushing effect and state under the guidance of the inclined pushing disc. Moreover, the inclined pushing disc is formed on the inner wall of the sleeve, the elastic resetting mechanism of the sleeve features simple construction and lower fabrication cost without need of any additional components. On the whole, the pipe connector of the present invention is characterized by simple construction and more stable guidance with improved applicability and industrial benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiments of the present invention.

FIG. 2 shows an exploded perspective view of the preferred embodiments of the present invention.

FIG. 3 shows a top view of the reducing flanged pipe and guiding lug of the present invention.

FIG. 4 shows a schematic view of the present invention where the inclined pushing disc is not abutted with the guiding lug.

FIG. 5 shows a schematic view of the preferred embodiments of the present invention.

FIG. 6 shows another schematic view of the preferred embodiments of the present invention.

FIG. 7 shows a cross-sectional view of another preferred embodiment of the present invention.

FIG. 8 shows another cross-sectional view of another preferred embodiment of the present invention.

### DETAILED DESCRIPTION OF THE INVENTION

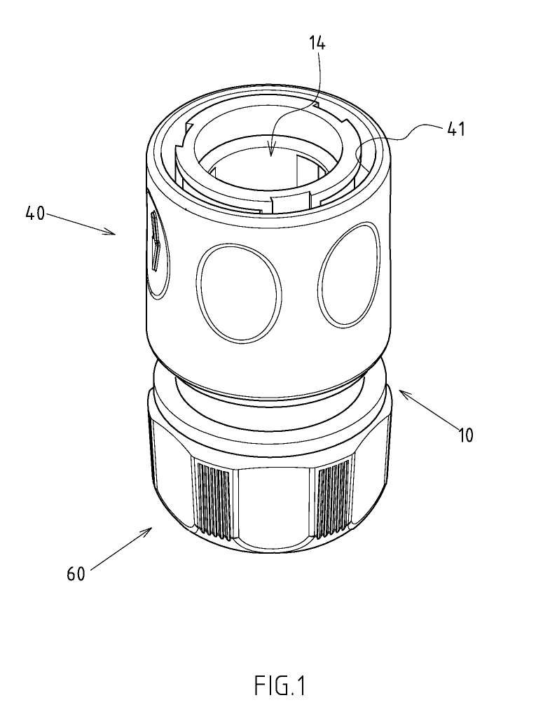

FIGS. 1-4 depict preferred embodiments of a pipe connector of the present invention, which, however, are provided for only explanatory objective for patent claims.

Said pipe connector includes a main body 10, at bottom of which there are an external threaded portion 11 and a plurality of convex teeth 12, and at top of which there is a reducing flanged pipe 13. A flange ring 131 is set at the bottom of the reducing flanged pipe 13, and several radial through-holes 132 are arranged at interval on the top of the reducing flanged pipe 13. An axial water through-hole 14 is set at the center of the main body 10. Several guiding lugs 20 are connected to the reducing flanged pipe 13 of the main body 10. The guiding lugs 20 are extended upwards, and provided with internal and external guiding surfaces 21, 22. The bottom of the guiding lug 20 is linked to the flange ring 131 of the reducing flanged pipe 13.

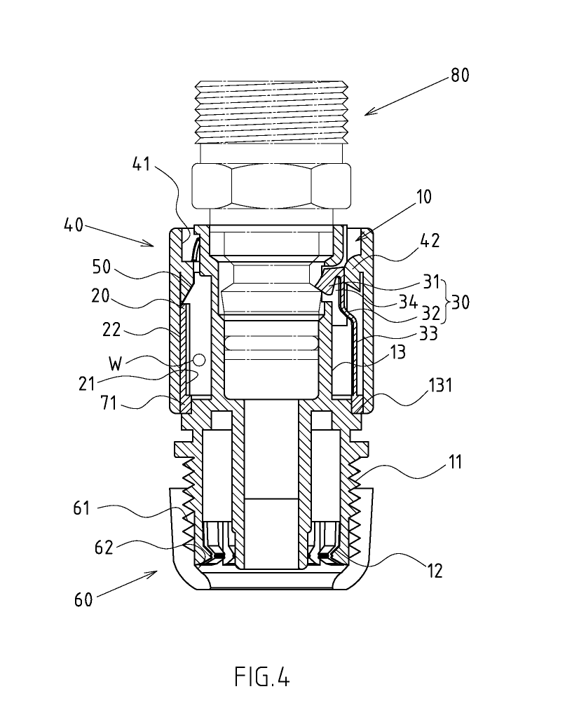

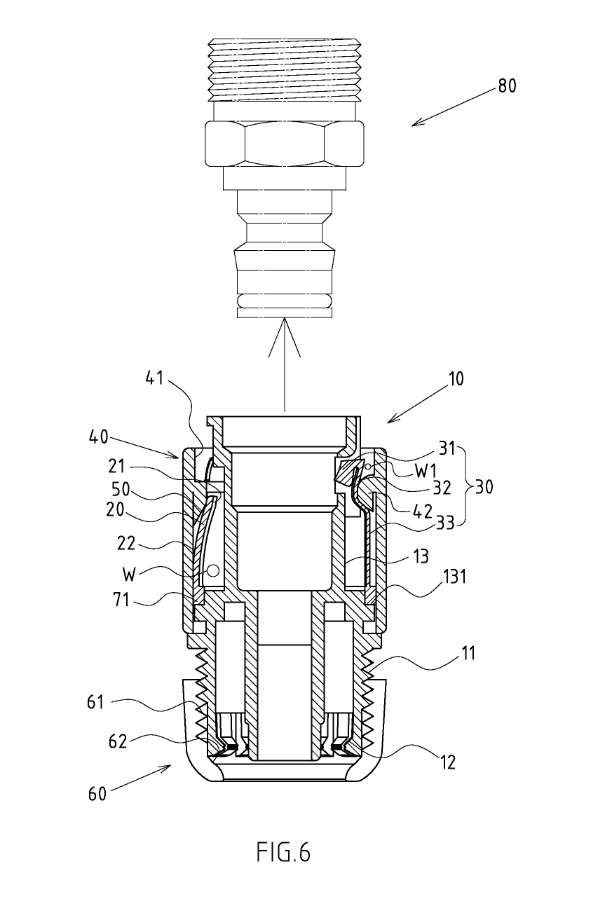

Elastic claws 30 are arranged between the guiding lugs 20. The elastic claw 30 comprises a fixture block 31, a recessed portion 32 and a rack 33. The bottom of the elastic claw 30 is abutted onto the flange ring 132 of the reducing flanged pipe 13. The fixture block 31 of the elastic claw 30 is protruded into the radial through-hole 132 of the reducing flanged pipe 13, and then protruded and inserted securely into the male joint 80 (shown in FIG. 6) in the axial water through-hole 14 of the main body 10. Moreover, a recessed groove 34 (marked in FIG. 4) is formed between the fixture block 31 of the elastic claw 30 and the interior of the recessed portion 32, enabling the fixture block 31 to be expanded flexibly.

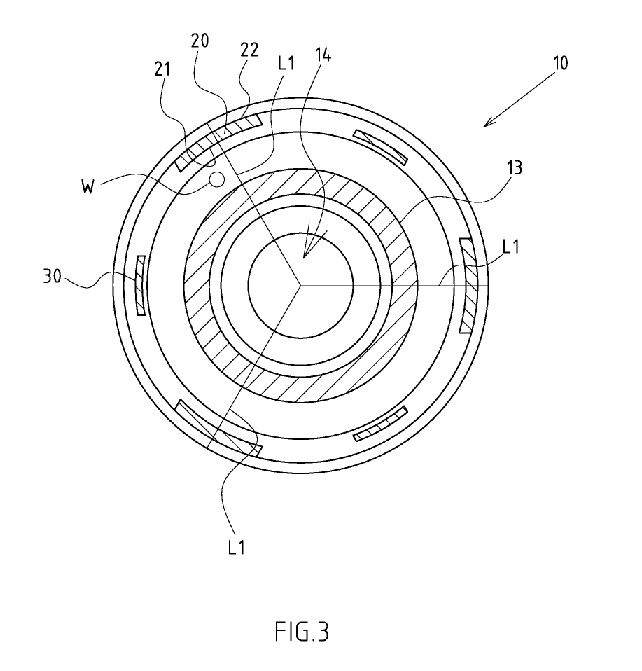

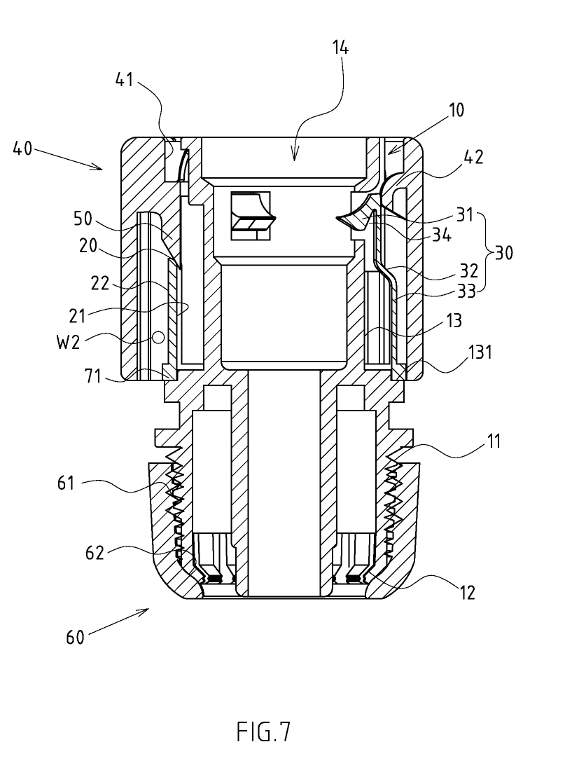

A sleeve 40 is sleeved around the reducing flanged pipe 13 of the main body 10. At the top of the inner wall 41 of the sleeve 40, the retaining flange 42 is aligned with the elastic claw 30. At the center of the main body 10, a radiative swinging baseline L1 (marked in FIG. 3) facing the inner wall 41 of the sleeve 40 is formed. Several inclined pushing discs 50 are formed on the inner wall 41 of the sleeve 40. The inclined pushing discs 50 are abutted with the internal or external guiding surface 21, 22 of the guiding lug 20. When the inclined pushing disc 50 is abutted onto the external guiding surface 22 of the guiding lug 20, a spacing W (disclosed in FIG. 4) is formed between the guiding lug 20 and the reducing flanged pipe 13. Referring also to FIG. 7, when the inclined pushing disc 50 is abutted onto the internal guiding surface 21 of the guiding lug 20, a spacing W2 is formed between the guiding lug 20 and the inner wall 41 of the sleeve 40. As the inclined pushing disc 50 is abutted with the guiding lug 20, the sleeve 40 can be supported and pressed forcibly to descend for a preset stroke.

A pipeline locking ring 60 is provided with an internal threaded portion 61 for screwing onto the external threaded portion 11 at the bottom of the main body 10. A pyramidal locking surface 62 is set at the inner bottom of the pipeline locking ring 60. The pipeline locking ring 60 is used to lock fixedly the water pipeline assembled onto the convex teeth 12 at bottom of the main body 10. When the pipeline locking ring 60 is locked up, the pushing state of the pyramidal locking surface 62 will force the gradual retraction of the convex teeth 12 so as to lock the water pipe.

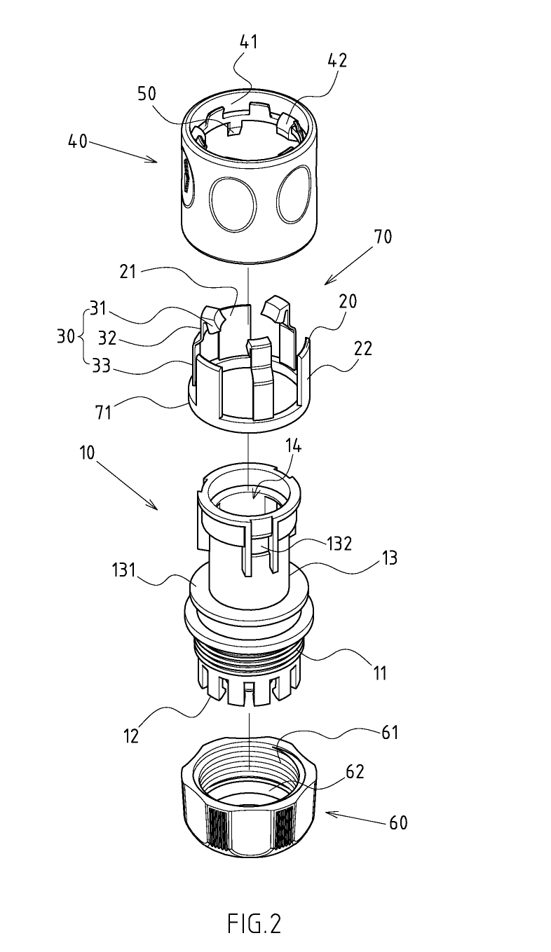

There are several preferred embodiments of the guiding lug 20 and the elastic claw 30. For example, the guiding lug 20 and elastic claw 30 are arranged on a chassis 71, forming a snapping seat 70 (disclosed in FIG. 2). The snapping seat 70 is mounted externally onto the reducing flanged pipe 13 of the main body 10, and the chassis 71 is abutted onto the flange ring 132 of the reducing flanged pipe 13. Alternatively, the guiding lug 20 is prefabricated outside of the reducing flanged pipe 13 of the main body 10, with the bottom of the guiding lug 20 linked to the flange ring 132 of the reducing flanged pipe 13. The elastic claw 30 is assembled at exterior of the reducing flanged pipe 13, and staggered with the guiding lug 20.

Based on above-specified structural configuration, the present invention is operated as follows:

Firstly, the structure of the pipe connector used to lock securely the existing male joint 80 of water pipe is described. Referring to FIG. 4, a recessed portion 32 is set below the fixture block 31 of the elastic claw 30, and a retaining flange 42 is set at the top of the inner wall 41 of the sleeve 40. When the sleeve 40 is not under a descending state, the exterior of the fixture block 31 of the elastic claw 30 is retained by the retaining flange 42, so that the fixture block 31 can not be expanded so as to lock securely the water pipe's male joint 80, of which the external view of the water pipe's male joint 80 is shown in FIG. 6. When the sleeve 40 moves down under the force applied by the user, the retaining flange 42 will descend synchronously to align with the recessed portion 32 below the fixture block 31. In such a case, the user can remove the water pipe's male joint 80, and toggle the fixture block 31 at the same time. As the fixture block 31 can be expanded flexibly due to the release spacing W formed by the recessed groove 34, retaining flange 42 and recessed portion 32, the user can release and remove the male joint 80 as shown in FIG. 6.

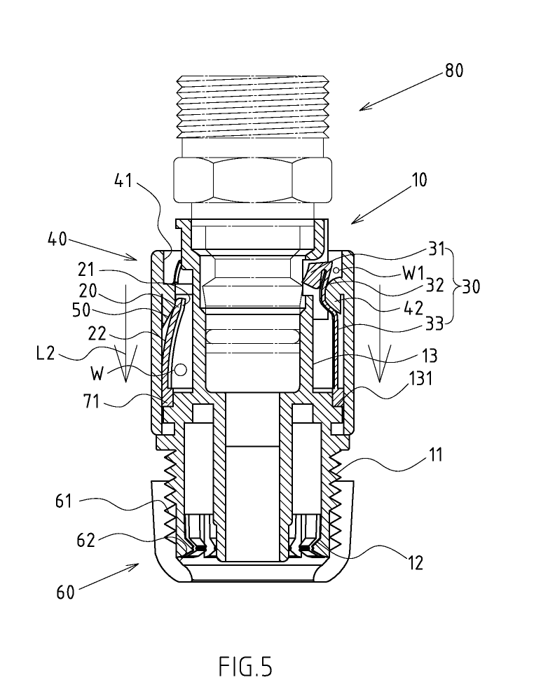

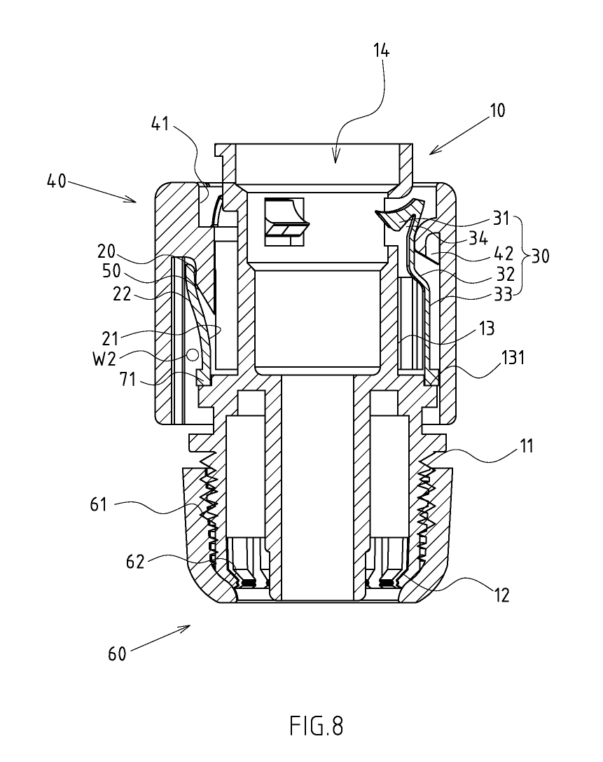

The elastic resetting mechanism of the sleeve 40 is described. Referring to FIG. 4, when the sleeve 40 is not under a descending state, the guiding lug 20 at the reducing flanged pipe 13 of the main body 10 is abutted with the inclined pushing disc 50 of the sleeve 40, the sleeve 40 can be flexibly supported and pressed forcibly to descend for a preset stroke. Referring also to FIG. 5, when the sleeve 40 moves down under the force applied by the user (shown by arrow L2), the external guiding surface 22 of the guiding lug 20 will swing towards the spacing W on the swinging baseline L1 under the guidance of the inclined pushing disc 50 (disclosed in FIGS. 4 6), or referring to FIG. 8, the internal guiding surface 21 of the guiding lug 20 will swing towards spacing Won the swinging baseline L1 under the guidance of the inclined pushing disc 50. With the accumulation of the resetting force, the sleeve 40 will be resumed to move up with the resetting of the inclined pushing disc 50 when the user releases the force.

I claim:

1. A pipe connector, comprising:
a main body, at top of which a reducing flanged pipe is set, and several radial through-holes are arranged at interval;
a plurality of elastic claws, mounted onto the reducing flanged pipe of the main body, and protruded correspondingly into the radial through-holes of the reducing flanged pipe;
a plurality of guiding lugs, connected to the reducing flanged pipe of the main body;
the
guiding lugs are extended upwards;
a sleeve, sleeved around the reducing flanged pipe of the main body; at the top of the inner wall of the sleeve, the retaining flange is aligned with the elastic claw; at the center of the main body, a radiative swinging baseline facing the inner wall of the sleeve is formed; several inclined pushing discs are formed on the inner wall of the sleeve; the inclined pushing discs are abutted with the guiding lugs;
with the lowering force applied to the sleeve, the guiding lug can be elastically accumulated to swing inwards or outwards on the swinging baseline under the guidance of the inclined pushing disc; when the force applied by the user is released, the sleeve will be resumed to move up with the resetting of the guiding lug.

2. The structure defined in claim 1, wherein the guiding lug and the elastic claw are arranged a chassis, forming a snapping seat; the snapping seat is mounted externally onto the reducing flanged pipe of the main body.

3. The structure defined in claim 1, wherein the guiding lug is prefabricated outside of the reducing flanged pipe of the main body.

4. The structure defined in claim 1, wherein the elastic claw forms a recessed groove.

5. The structure defined in claim 1, wherein the guiding lug comprises internal and external guiding surface; the inclined pushing disc is abutted onto the external guiding surface of the guiding lug; a spacing is formed between the guiding lug and the reducing flanged pipe.

6. The structure defined in claim 1, wherein the guiding lug comprises internal and external guiding surface; the inclined pushing disc is abutted onto the internal guiding surface of the guiding lug; a spacing is formed between the guiding lug and the inner wall of the sleeve.

7. The structure defined in claim 1, wherein the pipe connector is used for connection of water pipe.
